(19) United States
(12) Patent Application Publication
(10) Pub. No.: US 2015/0039359 A1
(43) Pub. Date: Feb. 5, 2015

(54) Component Based Mobile Architecture with Intelligent Business Services to Build Extensible Supply Chain Ready Procurement Platforms

(71) Applicants: Santosh Katakol, Mumbai (IN); Subhash Makhija, Westfield, NJ (US); Dhananjay Nagalkar, Bridgewater, NJ (US); Ajay Solanki, Mumbai (IN)

(72) Inventors: Santosh Katakol, Mumbai (IN); Subhash Makhija, Westfield, NJ (US); Dhananjay Nagalkar, Bridgewater, NJ (US); Ajay Solanki, Mumbai (IN)

(21) Appl. No.: 13/957,053

(22) Filed: Aug. 1, 2013

(51) Int. Cl. G06Q 10/06

(52) U.S. Cl. CPC G06Q 10/063
USPC 705/7.11

(57) ABSTRACT

The present invention is a tool for managing spend analysis, reverse auctions, sourcing, contracts, procure-to-pay processes, requests for proposals, supplier assessment and settlement processes. It employs hardware architecture and a software framework to provide a platform as a service that allows the user to create, store, report and manage bids, requests for proposals, contracts, bid data, spend analysis, and supplier scoring information from any of a number of mobile devices of various form factors.

### FIELD OF INVENTION

The present invention pertains to the procurement tools industry and, specifically, to tools for managing spend analysis, reverse auctions, sourcing, contracts, procure-to-pay processes, requests for proposals, supplier assessment and settlement processes.

### BACKGROUND

The Procurement Tools industry grew from nearly zero in the 90s to over $2 billion as of 2012. The industry grew with the innovations related to individual aspects of Procurement such as spend analysis, reverse auctions, sourcing, contracts, Procure-To-Pay processes, among others. In the last 5 to 8 years, these innovations have been focused on full suite procurement and integration of these individual modules while avoiding patchwork integration. Though patchwork integration works, it is not seamless. Seamless movement of data amongst these related functionalities remained difficult.

As the procurement industry has matured, it has enjoyed the benefits of availability of the procurement tools at competitive prices. But recently, procurement departments have begun demanding a significantly better experience as benchmarked by consumer technologies. Despite significant progress in the procurement solutions in the last few years, significant problems remained unaddressed. These problems include:
Low adoption rate among users due to difficulties of use and intuitiveness of the solution;
Low spend through these Tools thereby not realizing the benefits of the solutions;
Clunky data movement due to patch integration among modules, even though many of these products were sold as seamlessly integrated;
Use of multiple solution providers (one for spend analysis, one for contract management, one for P2P etc.), creating a hodge-podge of technical solutions; and
Expensive and time consuming integration with existing ERP and other systems.
As a result of these limitations of the available systems, large companies turned to Procurement Outsourcing as an alternative to these solutions. Hence, the Procurement Outsourcing industry rapidly grew in the last 5 to 7 years.

### SUMMARY OF THE INVENTION

A first objective of the current invention is to provide a solution that increases adoption rate among users by reducing difficulty and increasing intuitiveness. A second objective is to increase spend. A third objective is to provide seamless movement of data by a single provider and avoid expensive integration with ERP systems. A fourth objective is to provide a means for sourcing professionals to easily manage tasks from nearly anyplace. A fifth objective is to provide a means that allows a procurement company to tailor the system for its specific needs without having to create programming language or templates.

The present invention describes a unique process to create a procurement platform that can be extended into a supply chain with minimal effort. This unique design allows the platform to be hosted in the cloud, and implemented as platform-as-a-service (PaaS) with dynamic scaling, providing the ability to add new functionality. The platform covers the entire “Source to Settle” or “S2S” process including spend analysis, electronic reverse auctions, electronic Request for Proposals/information/quotes, Contract Management, Supplier Portal and Supplier assessment, Procure-To-Pay and payment settlement processes. Further, this platform provides the user a sourcing market intelligence workbench and the option to work from any electronic device including mobile devices.

Paas refers to the provision of a computing platform and the provision and deployment of the associated set of software applications (called a solution stack) to an enterprise by a cloud provider. PaaS provides all the infrastructure needed to develop and run applications over the Internet. Users can access custom apps built in the cloud, just like their SaaS apps, while IT departments and independent software vendors can focus on innovation instead of complex infrastructure. The PaaS application of the present invention allows users to increase speed of development with pre-loaded, customizable templates and to build applications without writing a single line of code. Users are able to quickly automate, change and support a wide range of business processes. Even a user that is not a trained developer will be able to use the present invention and take advantage of the functionality it offers.

In general, platform as a service arrangements provide a set of services aimed at developers that helps them develop and test apps without having to worry about the underlying infrastructure. Developers can create without needing to consider the cost, space and convenience issues related to provisioning the servers, storage and backup typically associated with developing and launching an app. Instead, a developer is provided the capability to write code, test and launch the application, and make changes to the application to fix bugs or add functionality. The present invention takes advantage of all that PaaS has to offer and incorporates those advantages in a framework set up to allow design of procurement solutions that are tailored to the specific users needs.

The invention is an architectural solution based on a vision that a buyer should be able to conduct the entire workflow from a mobile device. The focus is to provide a single procurement platform easy enough to use that it becomes an extension of the procurement professionals' daily life. The procurement platform of the present invention is comprehensive, mobile, extensible and scalable and embodies significant knowledge of Procurement processes, comprising reusable components and services specific to the procurement domain. These procurement specific components allow for rapid development of various business functionalities in sourcing and procurement. The components selected were integrated to create functionalities. For example, one such functionality is designed to enable the workflow of a category buyer. The unique design of the platform and the process to integrate these components creates a comprehensive procurement platform.

This state-of-art Procurement platform provides the following unique differentiators:

a) The Procurement Platform: comprises a single platform for conducting all procurement functionality by seamlessly integrated spend, sourcing and procurement functions and by including contextual and personalized search functions based on the user's profile and past activities. An embodiment of the platform further includes a unified supplier portal for sourcing and procurement tasks and is easy to integrate with ERP systems. It is simple to deploy and update and incorporates embedded knowledge and social networking capabilities. Specifically, the system uses and provides a combination of procurement knowledge with an intuitive and mobile platform.
b) Procurement Knowledge: is included in embodiments in one or more of: forms for multiple templates for RFP's, category specific supplier performance and risk management templates, categorization schema used in an automated spend analysis product, a supplier directory, intelligent opportunity assessment capabilities based on sourcing levers like demand aggregation, supplier consolidation and other effective factors, and may include a “sourcing workbench” which includes the ability to house research, strategy, templates and models in shared workspace allowing the user to build a common knowledge and tools base for a given team.
c) Special Features: An embodiment of the intuitive, mobile platform of the present invention may include end to end voice based navigation for quick access, a highly efficient method for creating an RFP and automating scoring especially well-suited to mobile users and/or voice commands, and simple means to award a contract and catalog. An embodiment of the present invention is preferably both device and browser agnostic and capable of handling any culture.

### BRIEF DESCRIPTION OF THE DRAWINGS

FIG. 1 schematic showing core components of the procurement platform of the present invention;

FIG. 2 schematic showing interrelationship between data sources involved in the procurement platform of the present invention;

FIG. 3 lists of tasks showing the platform support EAI and EDI integration standards;

FIG. 4 is a flowchart depicting an exemplary workflow of the invention;

FIG. 4-a is a flowchart of an exemplary worker's tasks;

FIG. 5 is a screenshot showing event wise savings by country and task list;

FIG. 6 is a screenshot of the dashboard of the present invention, showing icons for various create tasks;

FIG. 7 is a screenshot of the dashboard, showing means to upload document and send to Partners in the system;

FIG. 8 is a screenshot of the New RFP creation screen, with event timeline;

FIG. 9 is a screenshot showing Lot Details for auction event for valves, including bidder details;

FIG. 10 is a screenshot showing return from a request for a frequently procured item;

FIG. 11 is a screenshot showing a workbench which provide logistical data over a set period of time;

FIG. 12 shows an example scorecard to be completed by a user of the platform;

FIG. 12-a; shows a screenshot of the sourcing scorecard analysis data for multiple suppliers by item and team member;

FIG. 12-b; is a screenshot showing the score summary by criteria, supplier, and team member;

FIG. 13 is a screenshot showing a four-panel view of supplier spend for all suppliers listed bt geography, time, name, and category;

FIG. 13-a; shows a spend view by supplier entity name;

FIG. 14 provides a screenshot showing an opportunity assessment based on selected categories for a particular entity;

FIG. 15-a thru d are screenshots of the step-wise progression to create a sourcing event using category specific templates already provided by the system;

FIG. 16 shows the screen depicting automated scoring, bid analysis, and winner recommendations;

FIG. 17 is a screenshot of the lifecycle of a specified enterprise contract from request to approval;

FIG. 18 provides screen data depicting contract compliance with various contract metrics;

FIGS. 19, 19-a and 19-b provides graphic representations of a variety of metrics related to a specific supplier, including savings;

FIG. 20-a is a project management report showing progress toward particular milestones;

FIG. 20-b is a project management report showing status of a particular project.

### DETAILED DESCRIPTION OF THE INVENTION

The foundation of any good product design is a strong, core component based architecture. FIG. 1 illustrates a core component block diagram depicting an embodiment of the invention comprising thirty components. These components are considered the basic architecture building blocks of the overall platform. Other embodiments may include only a subset of these; still others may include these as well as additional components or may mix a subset of the thirty with additional components.

Regardless of the number and type of components, each embodiment of the platform is built on foundational components that can be reused during the various processes of and functionalities required by a procurement and supply chain.

### Core Procurement Components:

The Core Procurement Components (infrastructure) provides functionality for use which is accessible from the platform. The Core Procurements layer provides the ability to perform the basic but complex activities of providing the required support to host and scale the functionalities. These core procurement components include but are not limited to: Cache Manager function, Access control function, UI Generator, Authentication function, Content Delivery Network (CDN), and Search function. The core procurement components are either provided as a platform service or are provided by third party specialist providers. They enable the procurement foundation components (described in the next section) to execute the required functionality without the burden of managing the execution. Core procurement components help in building the business functions and also provide extensible architecture which by its very nature makes it very simple to add new business functions at later stages. Each core component serves a very unique purpose in the procurement platform and may all be incorporated in the platform or, perhaps, only a subset may be incorporated.

### Foundational Components:

In addition to the set of core platform components, there are foundational components which are considered to be the base of any procurement functionality. In the present invention, foundational components may include:
1. Item Masters—a centralized service to manage the goods and services for an organization (FIG. 1)
2. Supplier Master—a centralized service to manage common supplier base
3. Procurement taxonomy—common product and services classification language
4. Users profiles—rich user information to provide personalized experience in the platform
5. Organizational structure—reporting, functional and authority structure to closely align procurement activities to users role

Other foundational components may include such known functional capabilities as: Survey Section (FIG. 1) which provides means to select pre-set questions for which answers may be required to be submitted by a supplier or vendor and which answers may be automatically scored and/or a rating provided; File Manager for tracking identifying and locating files; Event Analysis (FIG. 1), for example, for returning a vendor list in accordance with characteristics selected by a user, or for employing the assigned rating to a supplier's response or responses; Auction Engine (FIG. 1) for setting up and conducting auctions; Scoring Engine for creating ratings related to a supplier's response to a set of questions served by the Survey Section; and Organization and Account Structure (FIG. 1), Customizable Fields (FIG. 1), and/or an Exchange Rate Monitor (FIG. 1). In addition, foundational components may also include any one, several or all of the following:
Authentication: (FIG. 1) An enterprise grade business application needs a good strategy around authentication. Authentication allows users to identify themselves to an application. The modes of Authentication can vary from simple username, password to complex biometric capabilities. With more and more businesses moving towards the cloud to cater to their business function, the need to have a single authentication scheme across the corporate and cloud business applications is a must. The current platform components give the flexibility for any business to use any of the following authentication schema: Single Sign On into Platform using Corporate credential; Social Platform Authentication (Gmail, Facebook, windows live id); Any Third Party Authentication.
Access Management (FIG. 1) caters to what a user is authorized to do within the business applications. Access Management is well integrated with the business's authorization rules. There is no need to redefine the authorization rules for a new business.
Search: (FIG. 1) One of the key features of better user productivity is the ability to search relevant business data across the enterprise and outside. Search in the current platform is an enterprise wide feature i.e. across/within business functions. It is coupled with security i.e., “a user gets to view what he/she is authorized to view”. Search is also integrated with an analytics component which gives it the ability to perform business intelligence enabled searches.
Notifications: (FIG. 1) Across the enterprise and users, “to notify” is the ability to inform of a business event occurrence. The Notification component can send notification via various mediums, e.g., email, chat, push notification to devices and text. The ability to send notification to various formats ranging from tablets, browser and application within/outside of the enterprise is one of this platform's unique functional aspects.
Exception Manager & Logging: (FIG. 1) A robust exception management identifier makes troubleshooting across the enterprise simplified. Logging of messages across the enterprise application helps in troubleshooting.
Data Access Application Block: (FIG. 1) An enterprise application in the cloud deployed in Platform as Service Model requires “data” to persist to multiple storage types. Examples include a relational database, big data, table storage or others. The Data Access Application Block removes all the underlying complexity of the cloud in terms of transient failures and allows the developers to concentrate only on the core business functionality development.
Caching & Audit Trail: (FIG. 1) functions are core to any technical application and are very standard in nature.
Workflow Manager: (FIG. 1) Software As a Service business applications cater to a variety of businesses with differing business processes. A sound workflow engine which gives the ability to define and tweak business processes at the core and with unique integration abilities to the other business processes inside/outside of the enterprise is a unique value proposition.
Transient Fault Handling Block: (FIG. 1) Cloud computing is a new environment with a lot of unknowns. It brings its share of problems in terms of intermittent errors while accessing cloud storage and network related issues within the cloud world. Transient Fault Handling is a required functionality to abstract these problems for the core developer.
Localization: (FIG. 1) Localization is a standard component which addresses internalization and globalization.
Document Versioning: (FIG. 1) The term “document” in the enterprise world is not necessarily defined as a word or excel document. “Document” can represent a contract, a catalog or any other business entities. The need to version these entities comes from the fact that end users would like to work or maintain different versions of the same business entity across the time dimension and hence promote some level of reusability. The concept of document versioning is synonymous to physical document versions.
Auto Scaling Application Block: (FIG. 1) Applications hosted in the cloud are often faced with the challenge to utilize the computing power in a cost effective manner. Depending on the load scenario there may be a need to add more computing power automatically without the need of any user intervention. An auto-scaling application block would allow addition of computing power in response to the system's needs rather than requiring a user's command.
Collaboration: (FIG. 1) Social collaboration is a standard requirement by most enterprise application in current times. The collaboration framework of this platform brings both social and document collaboration to the PaaS world.
Reporting and Analytical framework: (FIG. 1) All enterprise applications have data which is reportable and becomes historical across time and other dimensions. The need to stitch together all this data and apply intelligence over the stitched-together data will give the customer the ability to make more educated decisions based on the intelligent data and dashboards.

### Key Technical Aspects

In addition to the Core Procurement Components and the Functional Components, there are Key Technical Aspects of this invention. The application of the present invention comprises a Pure Play PaaS procurement platform both mobile and voice enabled. It is an enterprise grade application of the kind to be deployed in a Pure Cloud “Platform as a Service” Model. The application is designed to address a wide band spectrum of form factors and devices which range from tablet, to mobile, to browser. The invention boasts characteristics that make it a true enterprise-grade application in every aspect with core identity management capability (single sign-on) across businesses. The application, at its core, is a “Component Based Architecture” comprising the core procurement foundation services of the platform (see FIGS. 1 and 4). It employs a Unified Platform for complete sourcing and procurement functions, and integrates capabilities both within and on business or backend applications. The application embeds years of procurement intelligence and experience and is both device and browser agnostic, capable of handling any culture.
Identity Management & Single Sign On: (FIG. 2) An enterprise grade business application needs a good strategy for authentication. Authentication allows users to identify themselves to an application. The modes of Authentication can vary from simple username and/or password to complex biometric capabilities. With more and more businesses moving towards cloud computing to cater to their business functions, the need to have a single authentication scheme across the corporate and cloud business applications is a must. The Platform Authentication component gives the flexibility for any business to use any of the following authentication schemes: Single Sign On into the platform using Corporate credential; Social Platform Authentication (Gmail, Facebook, windows live id); Any Third Party Authentication. Access Management caters to what a user is authorized to do within the business applications. Access Management is well integrated with the corporate authorization rules. The application does not require a business to redefine its authorization rules but can be set to use what's already been implemented.
Integration Out of the Box: (FIG. 3) The application provides out of box capabilities to integrate with any application already employed by the business. It supports most EAI & EDI integration standards. See FIG. 3

### Benefits of the Application

The present invention typically lowers operational costs and enables better margins in a competitive market and also lowers the cost of development resulting in a lower price to customers. Due to the faster cycle time for features, the application enables more configuration options and easier customization of features. The application offers scalability, which is inherent to the cloud platform and allows the application to meet varying customer demands. Performance is enhanced above those platforms that are not cloud based. The enhancements resulting from the cloud environment include: load balance on multiple actual or virtual servers across the globe; continuing provision of existing functionality in an easy to use, seamlessly integrated fashion; access to innovative differentiations leveraging the latest technology; and easy addition of new features and products. (See FIG. 4a)

This component based design also has several benefits to the end user. Common components serve multiple functionalities providing an unparalleled, consistent, and comprehensive experience of the platform which breaks away from the traditional modular architecture needing import/export functionalities amongst modules. As an example, goods and services needed by an organization using the present invention are contained in a single Item Master.(labeled “Item” on FIG. 1) This item master is used in all procurement functionalities including spend analysis, sourcing, contracts and P2P. Hence when any user wants to retrieve or add an item it is always served in the exact same fashion alleviating a need for exporting and then importing those items in different functionalities. Similarly, suppliers are also hosted in a common repository and hence the supplier invite process from any functionality is identical. The process of finding a supplier, and the process for selecting a supplier is the same throughout the platform.

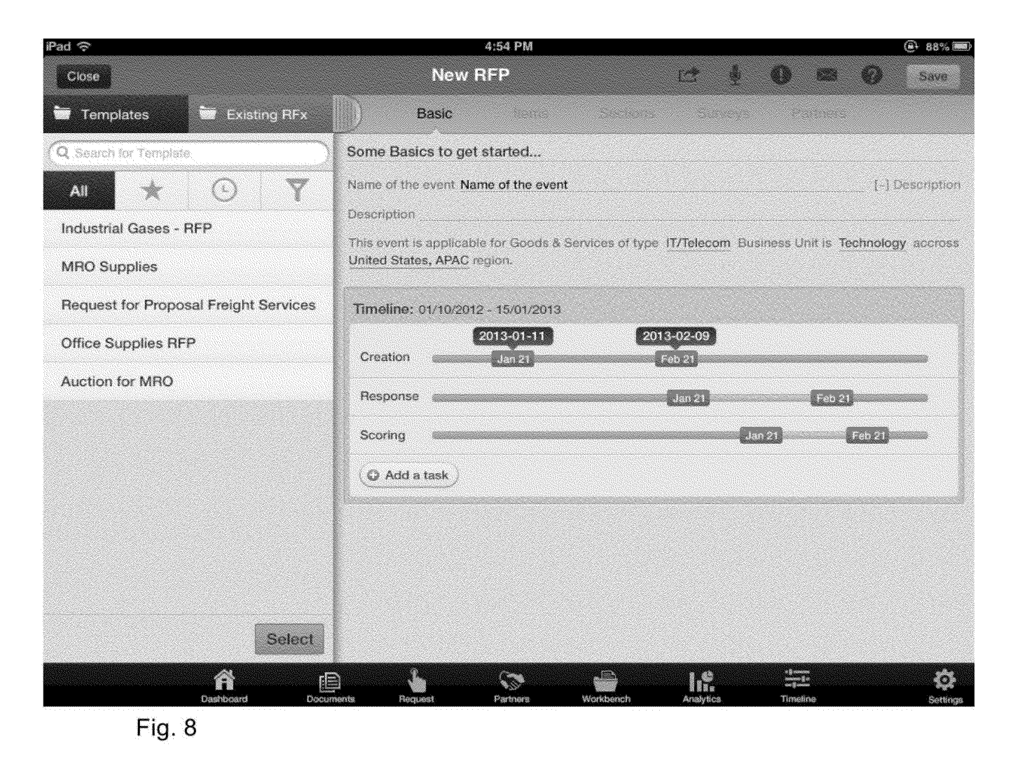

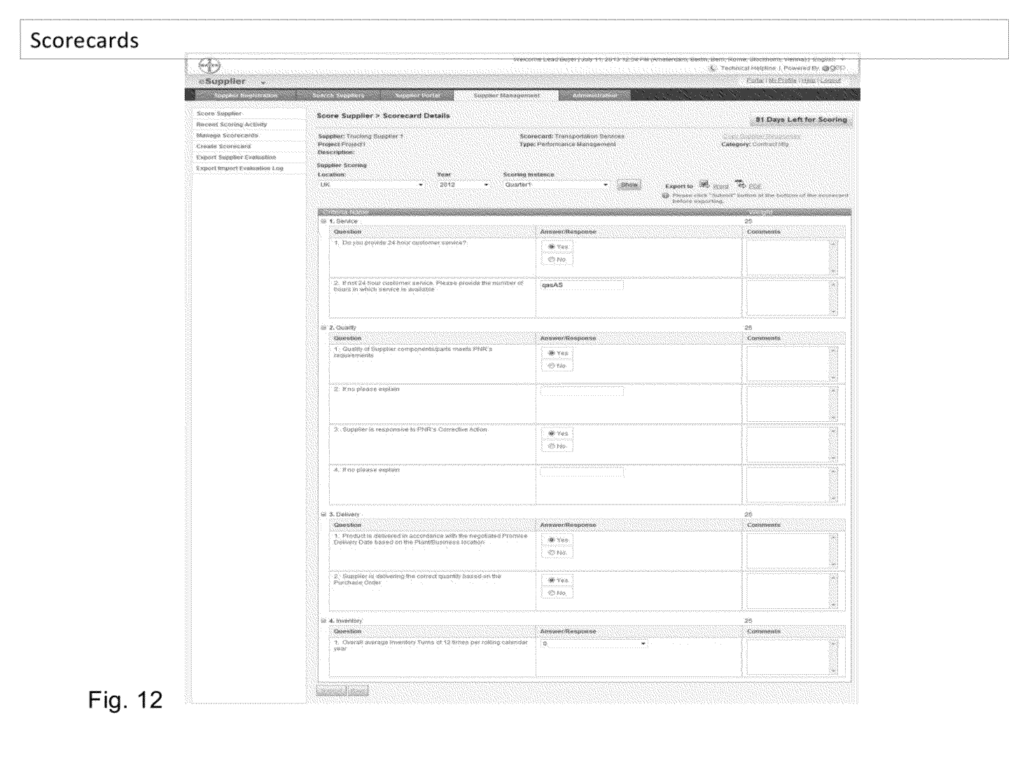

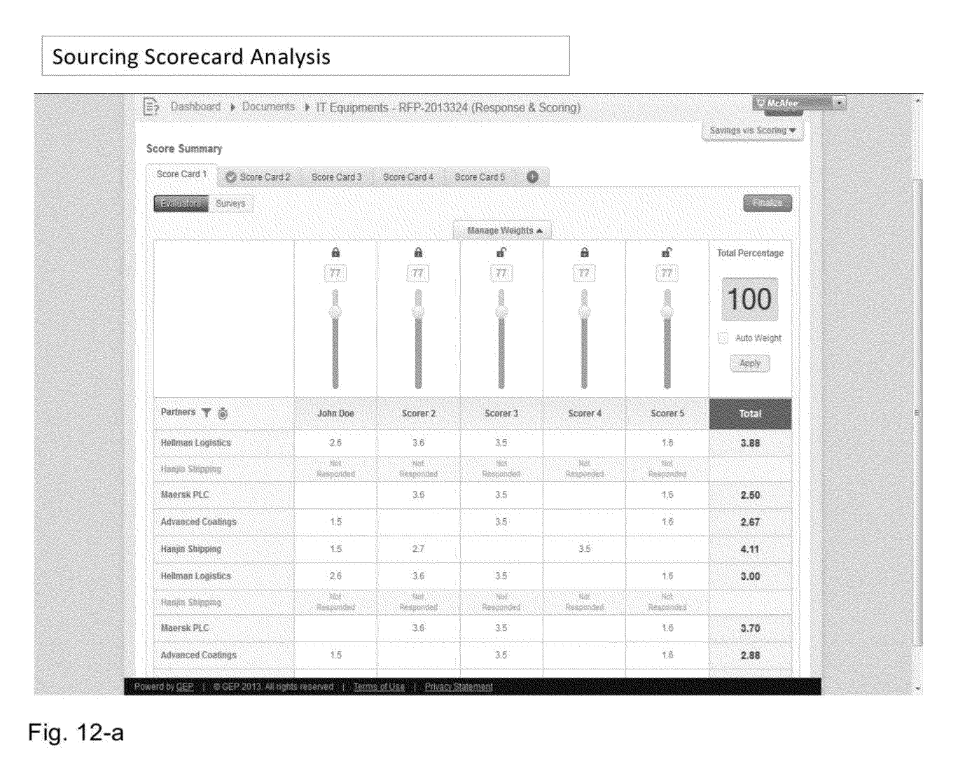

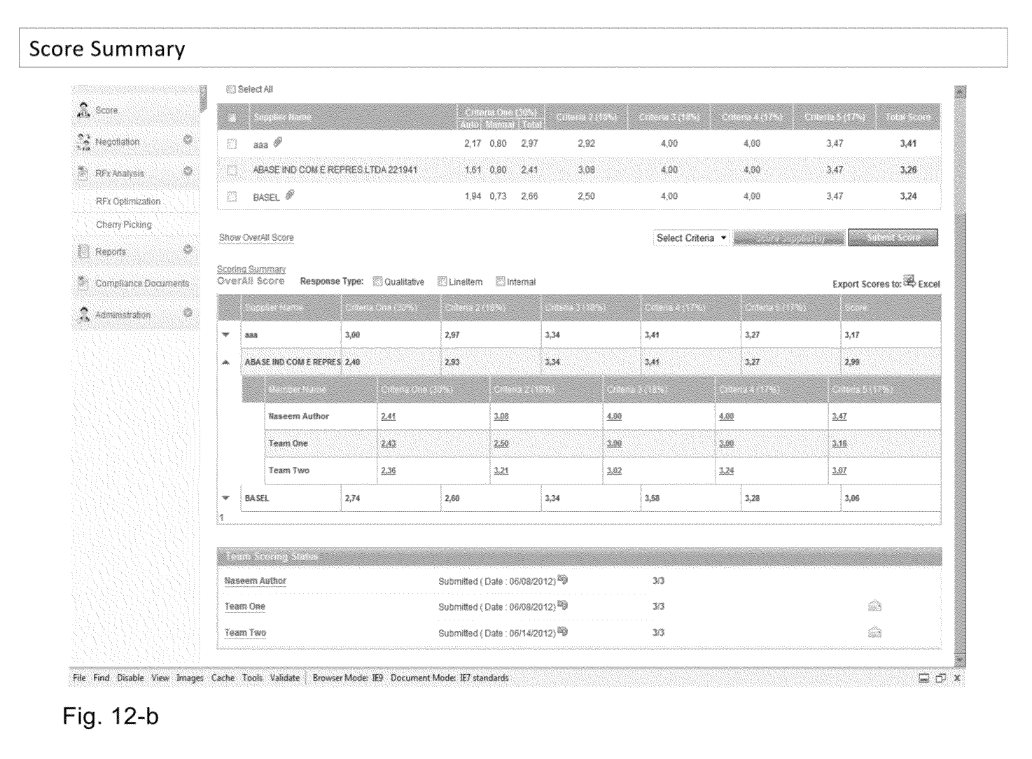

Components such as these can also be used in the supply chain extension of the platform. For example the item master can support an inventory capability of the platform. This concept is also extended to business components such as a scoring process (see FIG. 1 at “Scoring Engine”) related to suppliers or a response from a supplier is identical using scoring component. The scoring component can be used to evaluate suppliers during the RFP (Request for Proposal) proposal or can also be used for the strategic evaluation of the existing suppliers for balanced score card purposes. See FIGS. 8, 12, 12-a, and 12-b.

Utilization of common mobile interfaces is another advantage of this platform. The platform leverages a framework which allows the user interface to be designed for a variety of devices including iOS, Android or Windows 8. This native platform gives the user the feel of a solid platform and the user experience remains the same when the user moves from one interface to another interface. See FIG. 4a.

The design allows the user to extend the functionality of the procurement platform to other aspects of the Supply Chain. For example, to create an inventory functionality one can use the Procurement components of Items, Partners, Users, Workflow, and Reporting etc. These components can be brought together to build and launch an inventory tracking and reporting product in a rapid manner.

### Example of an Integrated Workflow:

A list of tasks that may be quite typical in a work session of a user of the application is provided below and illustrated at FIGS. 4 and 4a. This list is for illustrative purposes only to give context to the information provided herein:
Strategic Buyer Sam logs in to the Platform (Using an application on an iPad)
Sam lands on the workboard where he can see his tasks, reports, activities and 5-6 widgets
Sam now uses the voice feature to create a new Sourcing event (e.g. to submit to a supplier or suppliers a request for information, perhaps through the Survey Section, which information is used to select a supplier)
Sam uses an existing IT category template to create the Sourcing event
Sam views the summary of the sourcing event created
Sam adds suppliers and then publishes the event or publishes the event to the Partner Network port
Next, Sam views a scoring-in-progress event and scores the event
Then, Sam views an open live auction to view the auction bid graph and details
An event has just completed and bid analysis needs to be done. Sam opens the event to complete bid analysis and award the event to a supplier
Sam awards the event to the supplier and creates a Contract using the same event which pre-populates some of the Contract
Sam opens another negotiated contract and redlines the same.
Sam signs the contract and publishes it as a catalog for internal use
Sam searches through the catalog, and compares items to create a request or a new order.
Sam gets a report on how much time it took to complete each of the activities and how he performed against the budgeted time.

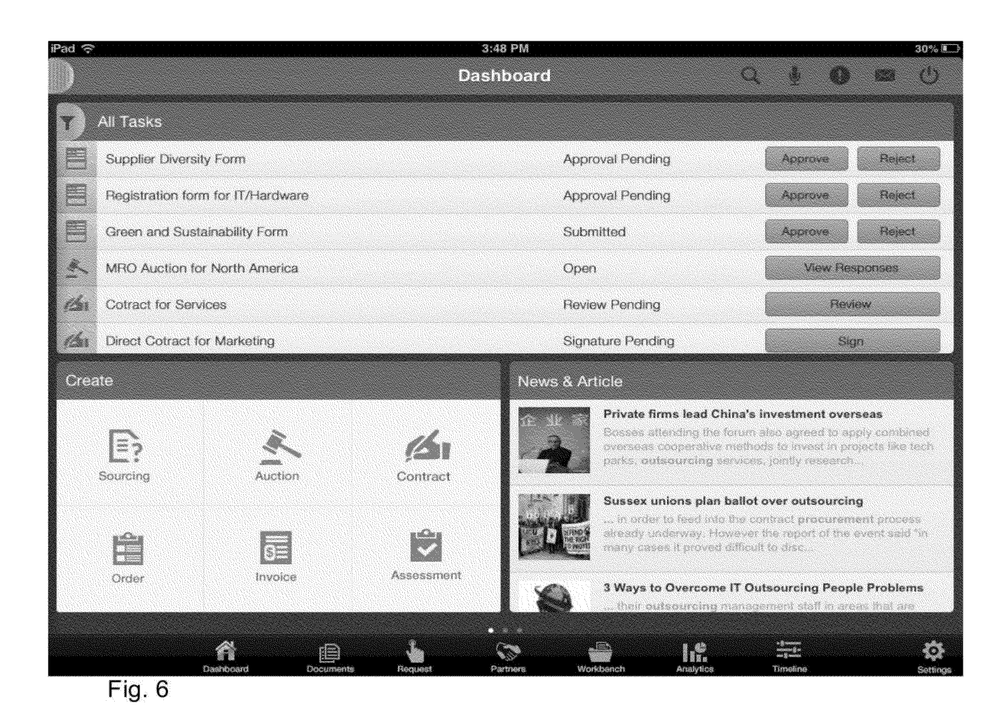

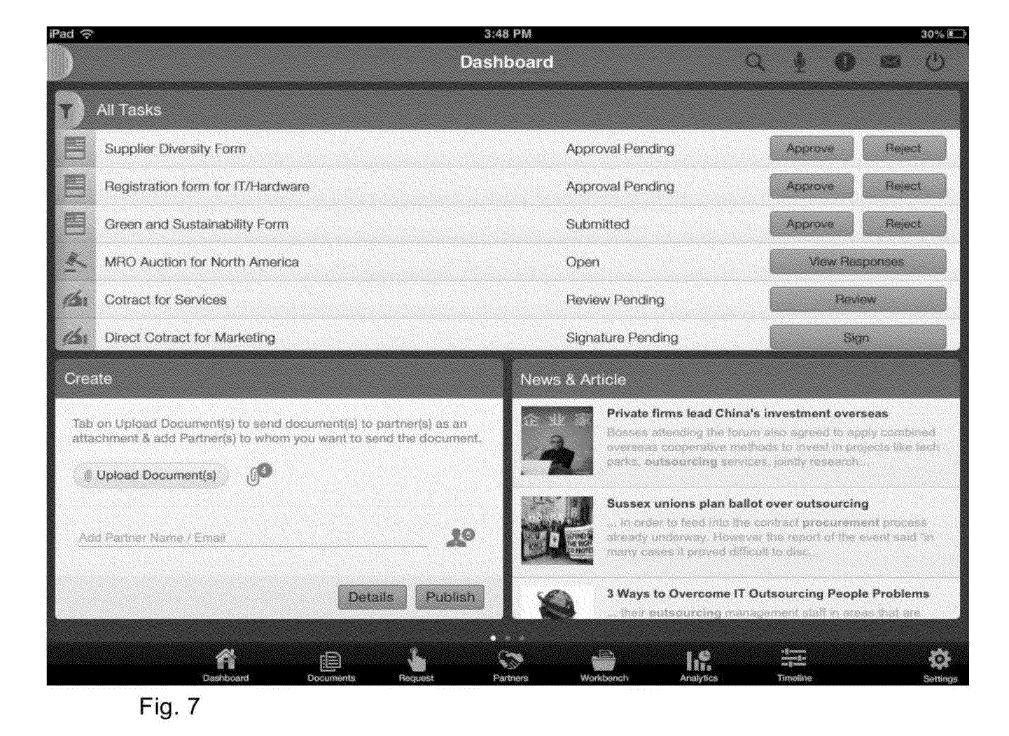

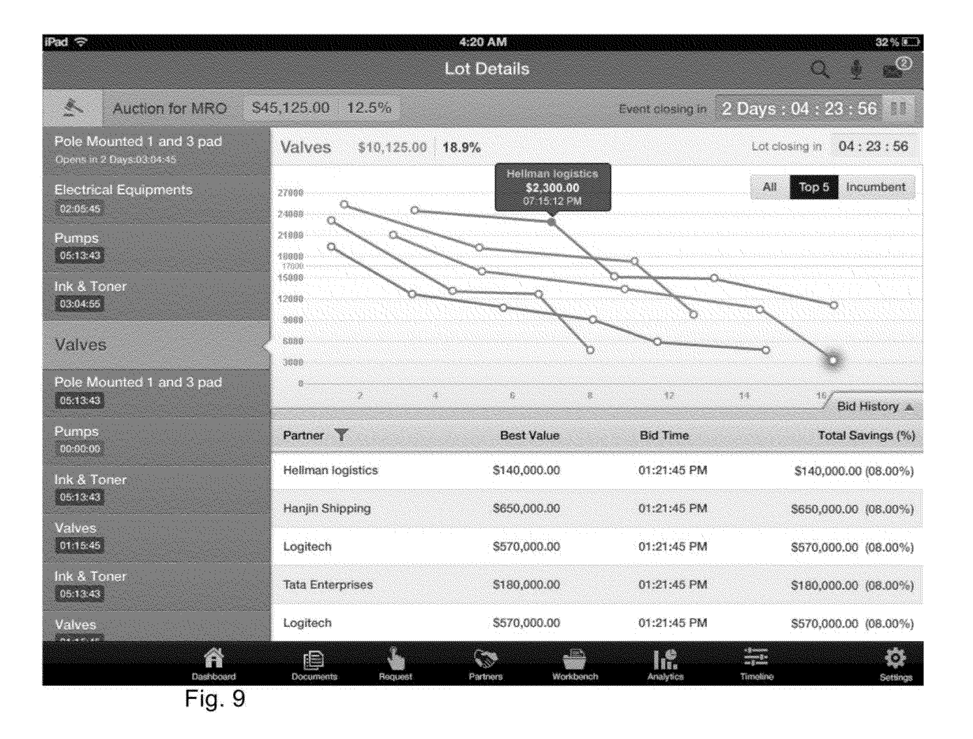

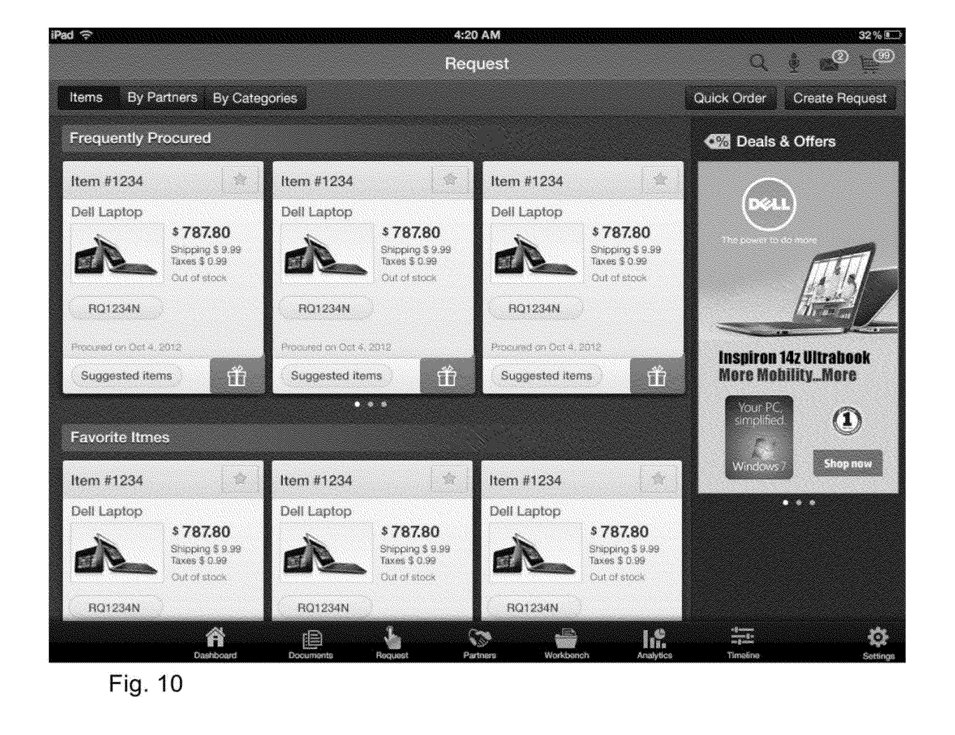

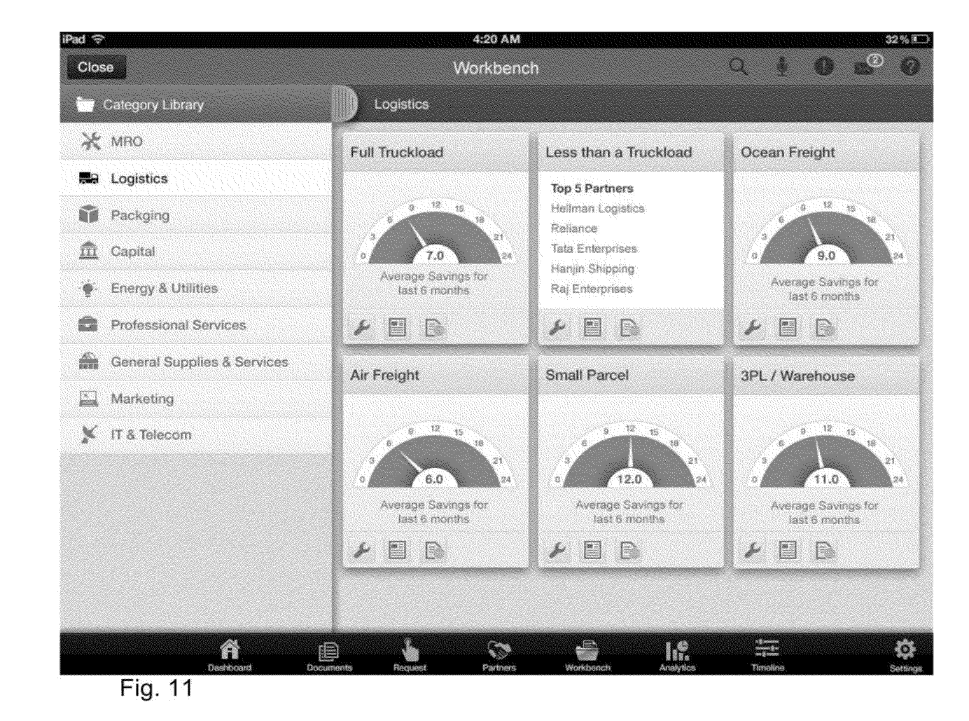

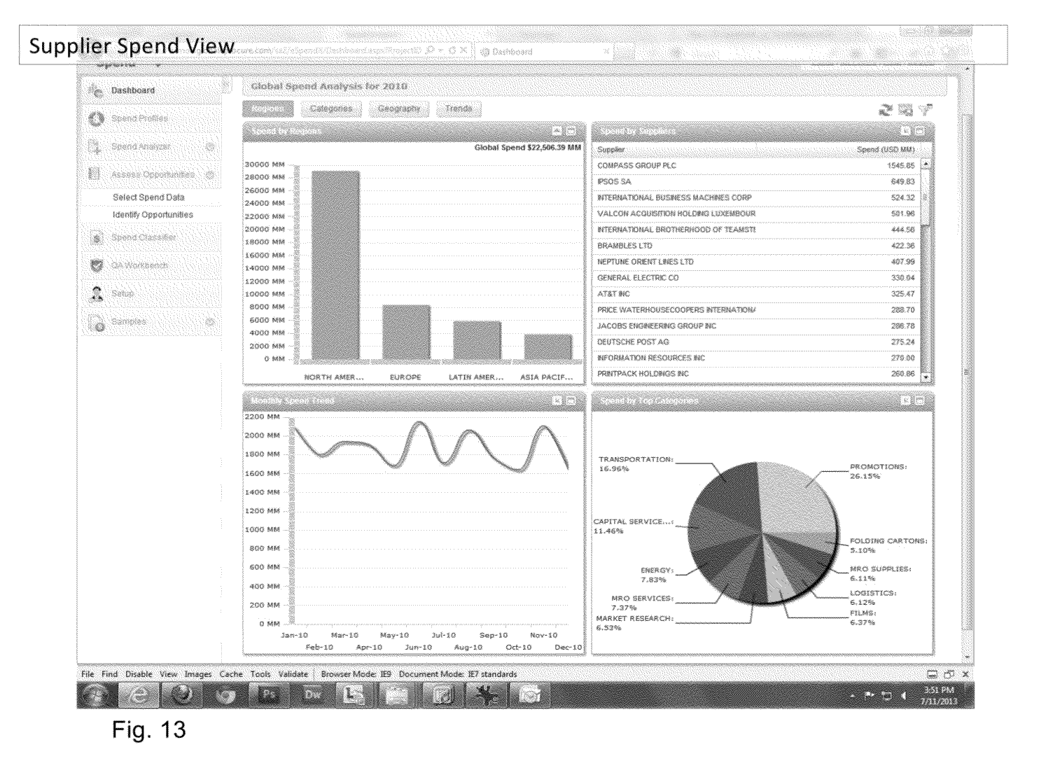

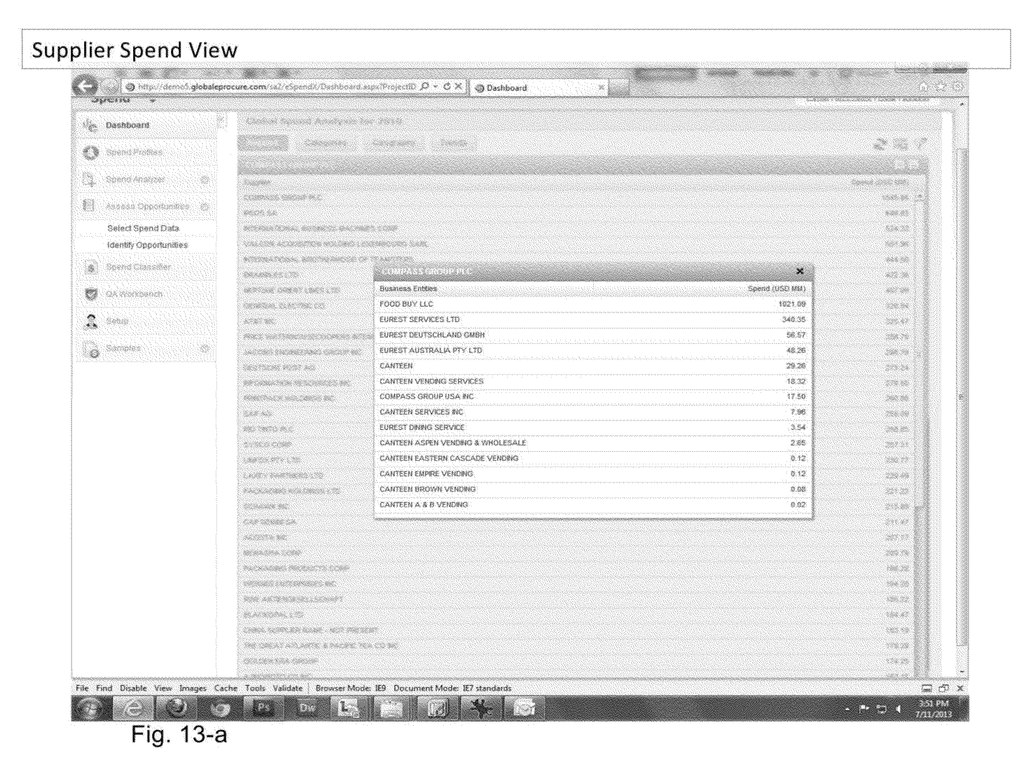

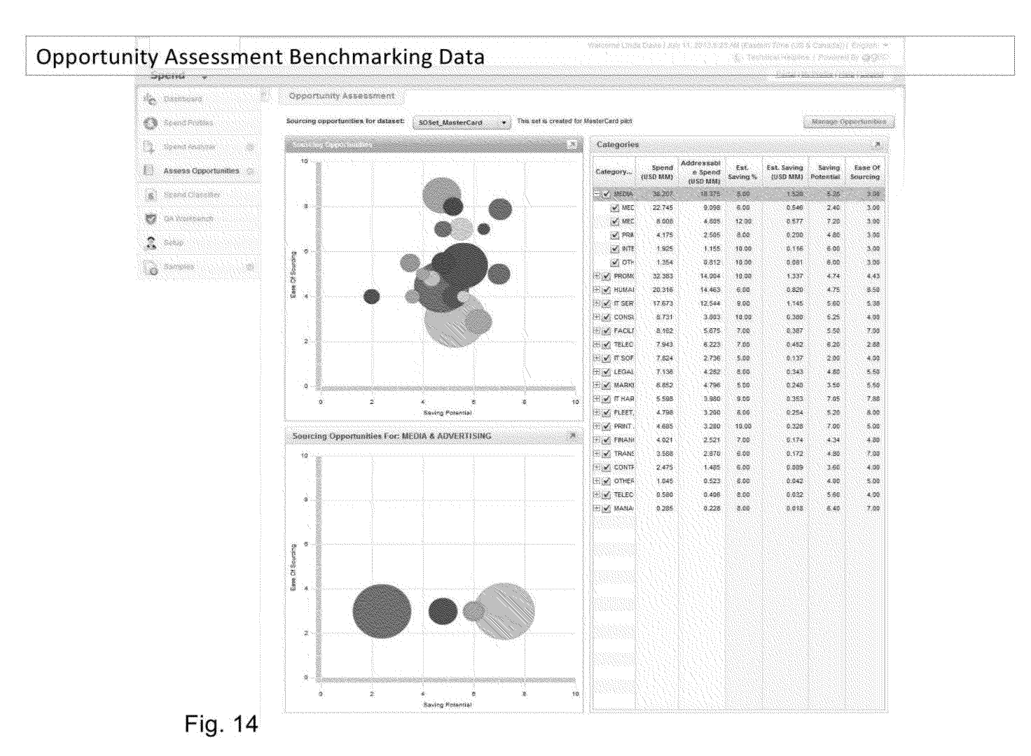

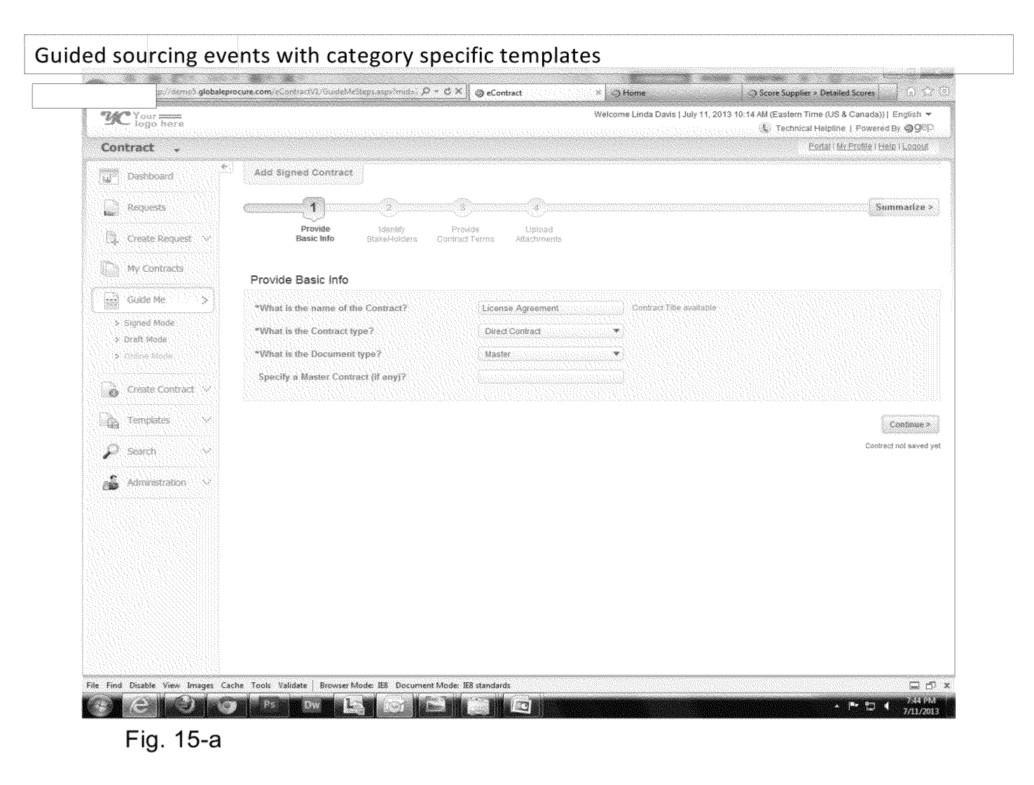

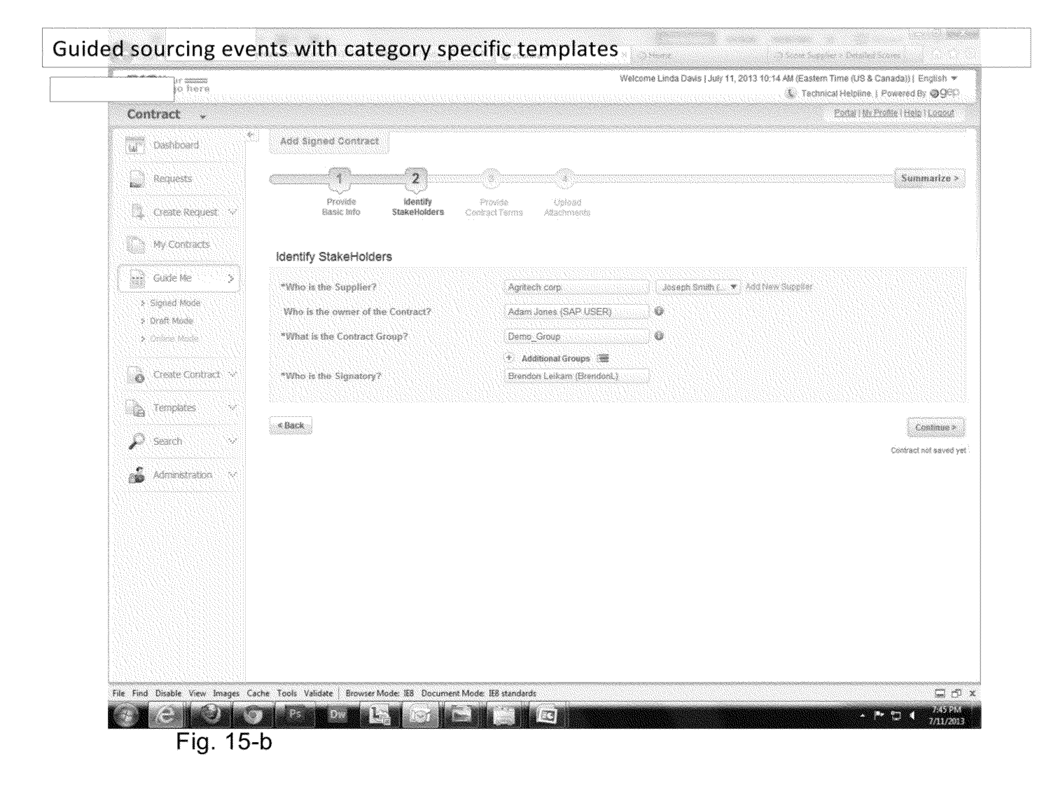

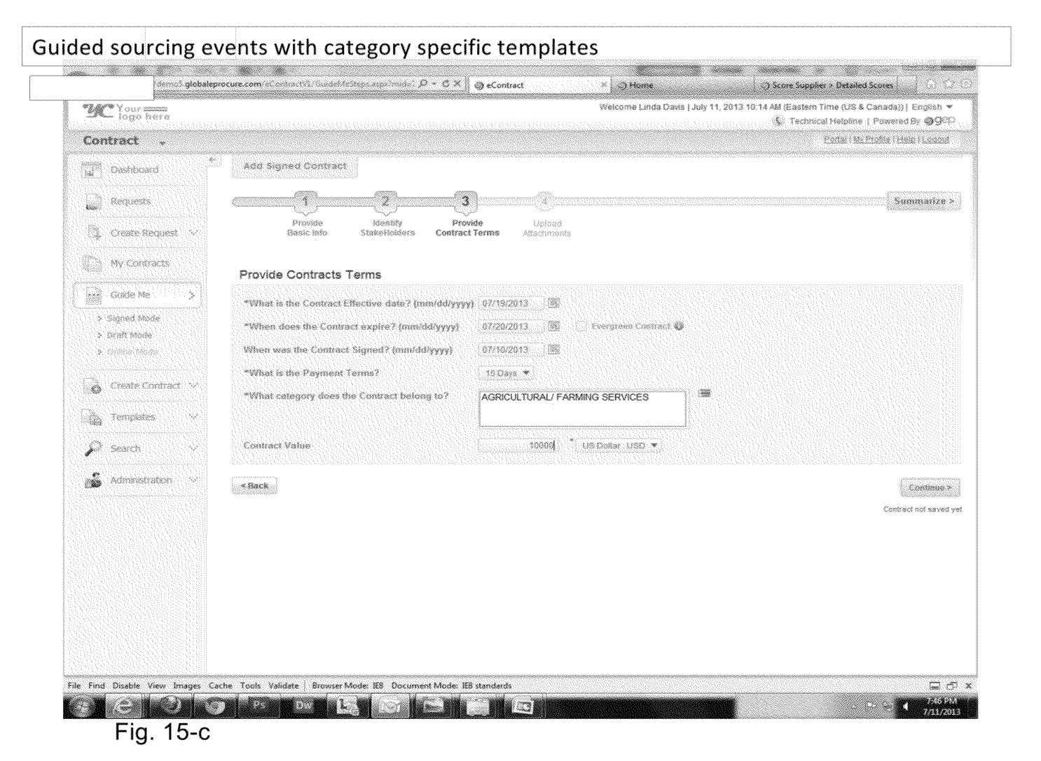

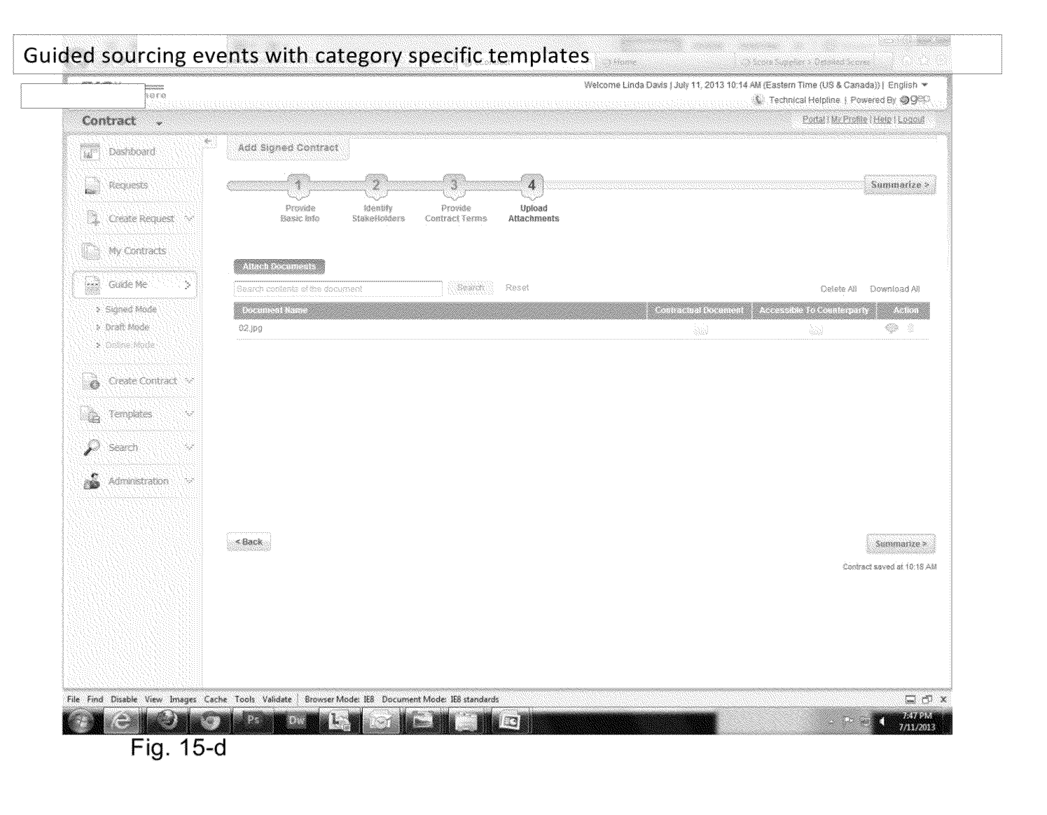

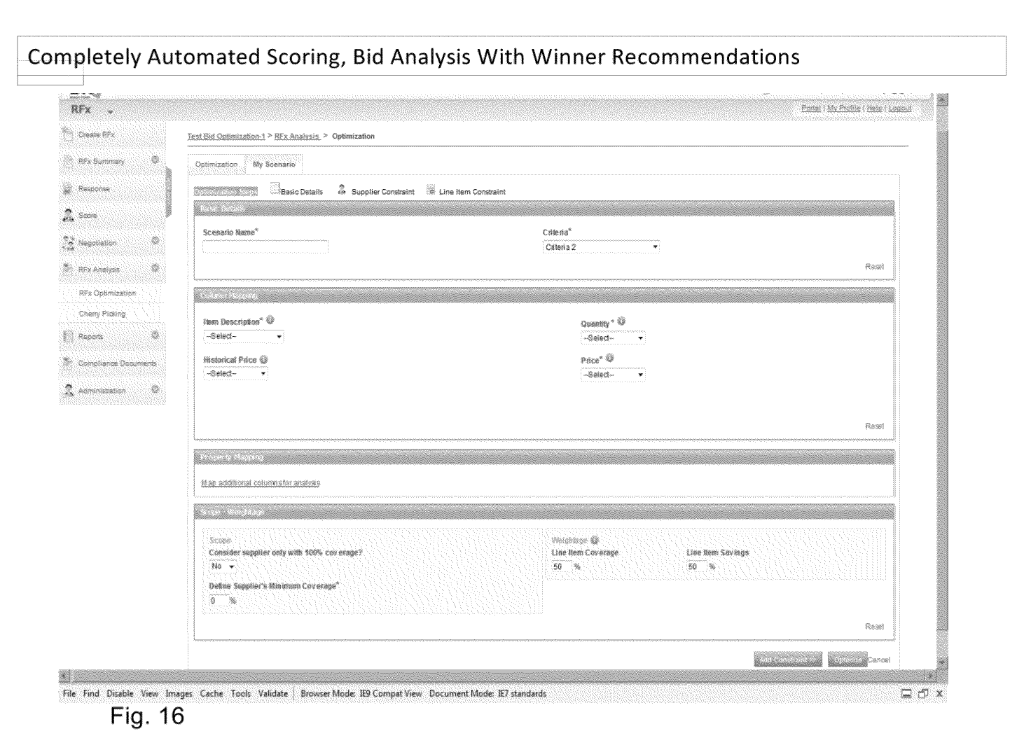

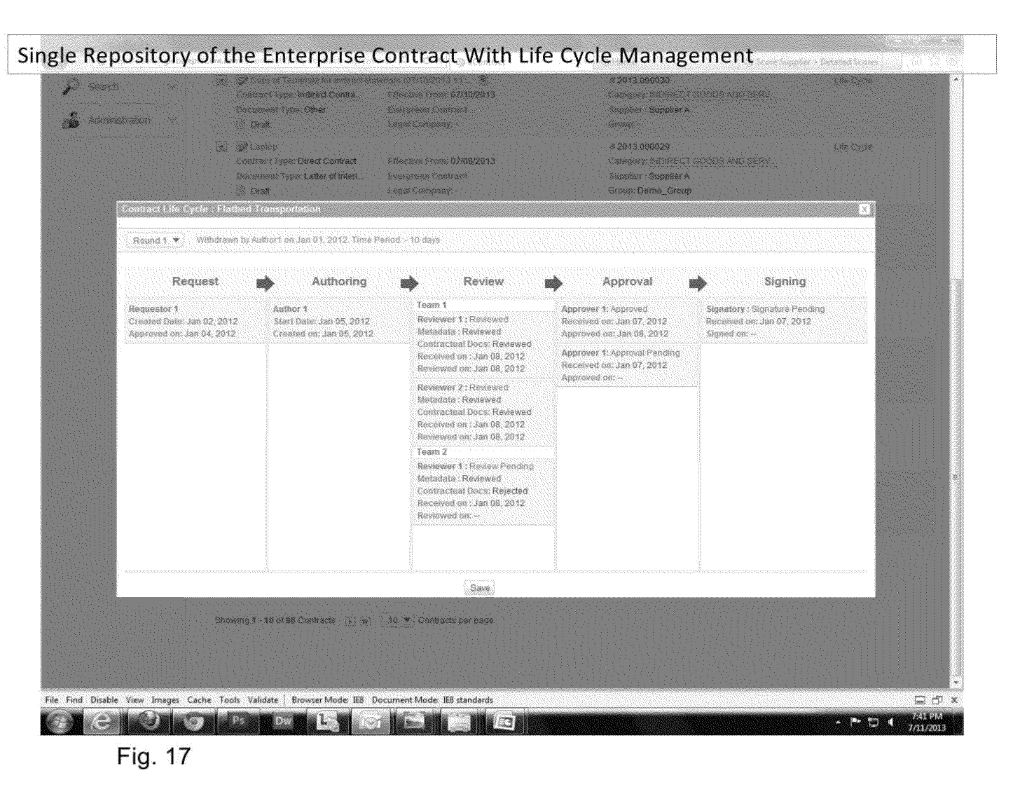

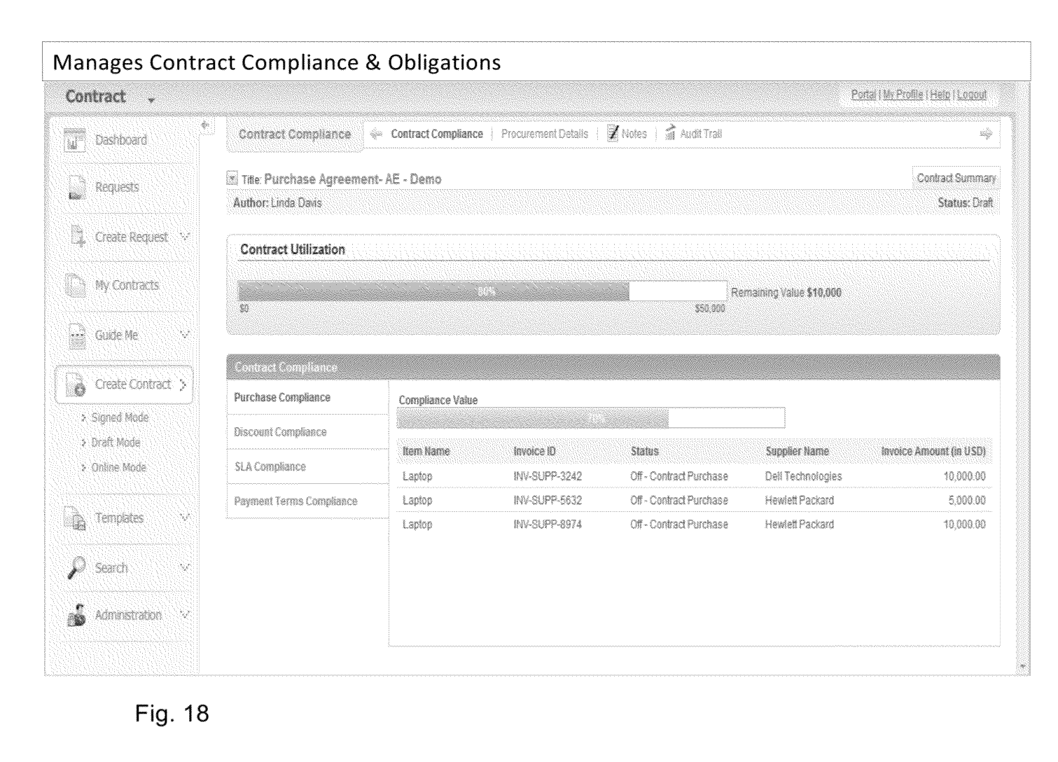

Functionality Under the Platform
Consolidated view of spend across enterprise is provided, typically through multiple screens which may describe or depict:
   Automated aggregation, cleansing, and normalizing of data using an Artificial Intelligence based system that learns. Real-time human feedback and ability to change classification
   Single consolidated supplier spend view through parent-child linkage to every single variation (FIG. 13 or 13a)
   Understandable sourcing-focused taxonomy for wider adaption amongst procurement professionals (also capable of UNSPSC, SIC-Code, home grown taxonomies, etc)
   Sourcing strategy directed to detect savings opportunities which may also be called a hunt.
   Opportunity assessment which provides benchmarking data (FIG. 14)
   A State of Art reporting framework which provides views from an enterprise view to a line item view and everything in between.
   Reports which are flexible in nature—clients assist in defining reports and therefore have flexibility in creating their own tool
   Reports that can be exported, mailed and scheduled in different formats (pdf, word) for further manipulation
Category Workbench (see FIG. 11) provides the persistence knowledgebase for your procurement:
   Workbench allows users to search, store, categorize and share market intelligence with his/her colleagues within and outside the organization. These documents are stored in the cloud and can be retrieved and shared with the colleagues. The workbench functionality allows a user to complete entire sourcing workflow and still remain within the platform. This capability increases the adoption of the platform and makes the change management process simpler. The workbench can be used for building a repository of: market intelligence, RFP templates, Category Negotiation strategies, Pricing worksheets, Supplier specific strategies, etc. The built-in features of the sourcing workbench allow users to pull the appropriate document within the platform and continue to carry remaining workflow thus improving productivity and providing intelligence to the procurement professionals. Specifically, the Workbench provides the following benefits:
   Single stop for all category specific information across the enterprise
   Storage for research, strategy, historical events, templates and models in one place
   Access to supplier directory tailored to the category (FIG. 5)
   Access to all the data for items ever solicited, contracted, procured or inventoried
Low resistance Bid solicitation and negotiation features:
   Guided sourcing events with category specific templates (FIG. 15a, b, c and d)
   Completely automated scoring, bid analysis with winner recommendations (FIG. 16)
   Supplier discovery through a supplier network
   Publishing of solicitation to credible suppliers.
   Strategic reverse auctions to improve savings further
   Panel auctions to leverage excess capacity at the suppliers
Streamlined and controlled contracting process to manage the exposure
   Provides ability to author contracts directly within the tool—either via Microsoft word integration or authoring directly within the tool e.g. FIG. 8 and more specifically FIG. 15(a)
   Facilitates collaborative authoring via the platform access and the features of the system to bring the experts into the contract negotiation process
   Provides a single repository of the enterprise contract with life cycle management (FIG. 17)
   Includes ability to set notifications for custom dates and notifications for milestones
   Provides templates and clause library for easy creation
   Contract repository allows clients to keep track of past agreements
   Manages contract compliance and obligations (see FIG. 15c)
Efficient and functional supplier management
   Provides central place for information about all of procurer's suppliers—keep information updated and stored (See FIG. 5)
   Facilitates easy document and information exchange with supplier (see FIG. 6)
   Employs electronic tracking to pre-screen, assess, audit, develop, improve your supplier base
   Drives Diversity, sustainability, code of conduct and other initiatives
Quasi automated requisition system
   Provides ability to upload catalogs (hosted) or punch out to a supplier site (punch out) to access catalogs that have pre-negotiated prices for buyers to purchase from—compliance ensured
   Facilitates creation of requisitions, receipts, and purchase orders from catalog items—creation is quick and easier since information is already prepopulated (see FIG. 9)
   Provides views and creation of invoices within the tool to process a purchase order (“PO”) flip
   Operates to provide a 3-way or 2-way match available, matching of PO/Invoice/Receipt or PO/Invoice before payment is made
   Integrates directly with ERP system to ensure real time updates of system

### Compliance and Savings Tracking

Since the user conducts the entire workflow in the platform and the platform keeps track of all transactions, the process of compliance is simplified. The platform can report compliance with contracts, vendors, prices, volume and other company specific buying policies. Company specific policies can be ruled into the platform and reporting made available around myriad compliance factors such as:

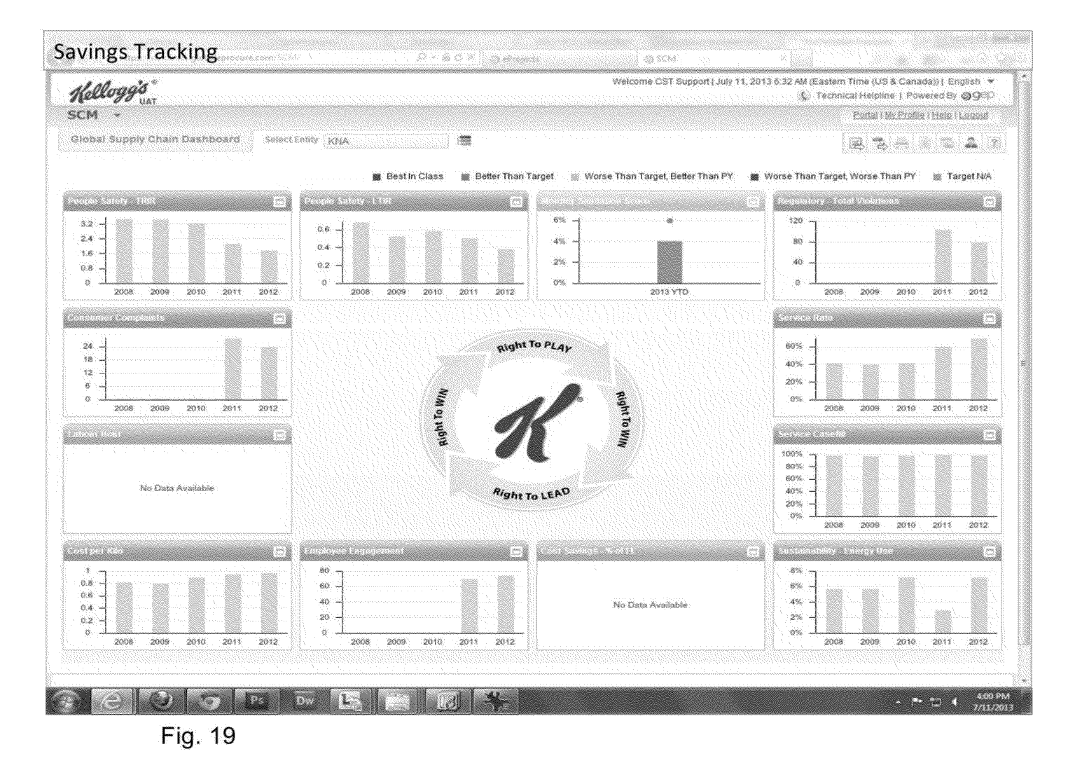

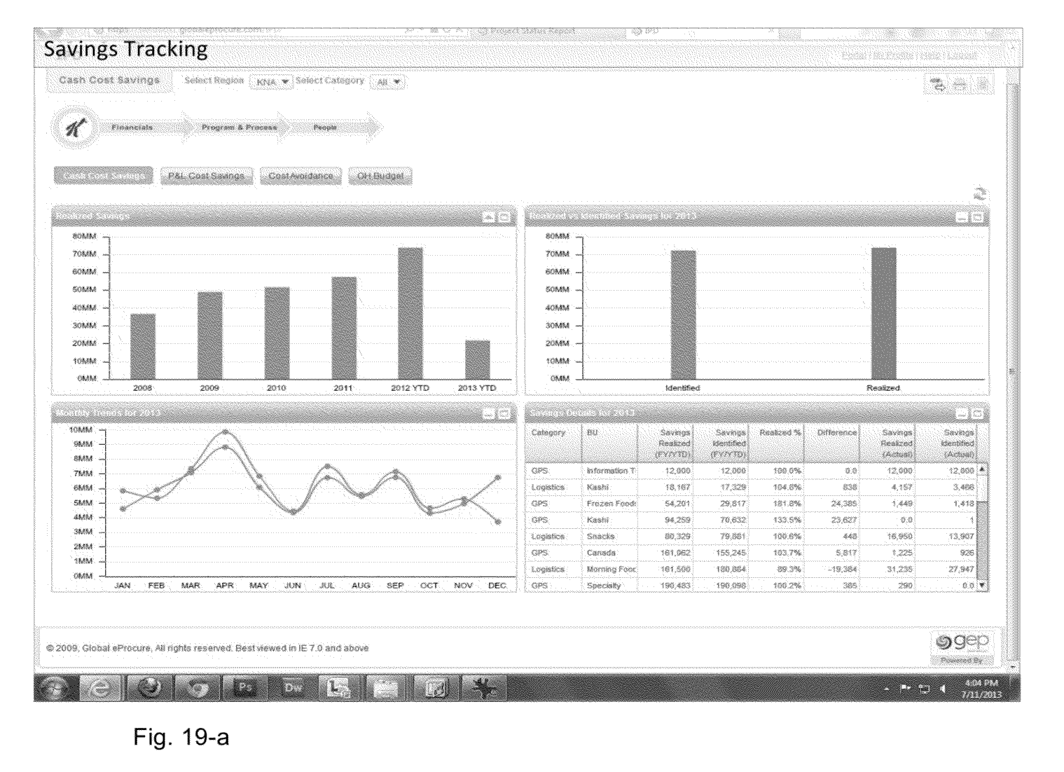

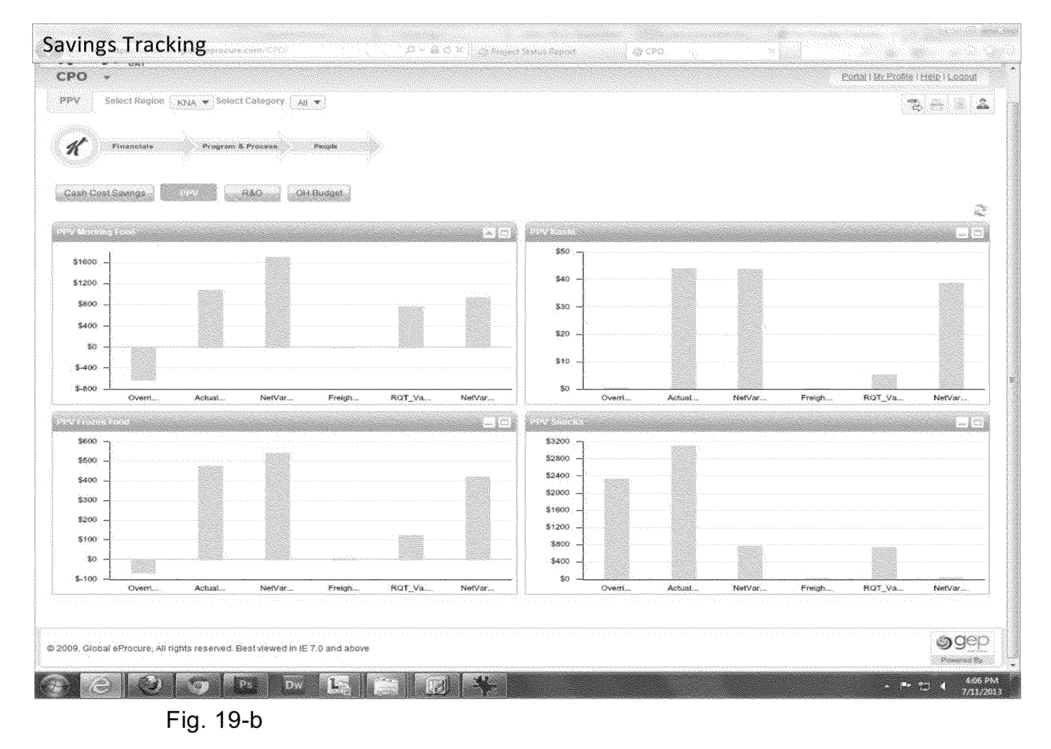

Price compliance: (see FIGS. 19, 19a and 19b)
The system allows comparison of negotiated prices with the actual prices and reports the level of compliances against line item prices.

### Volume Compliances or Demand Management:

The system allows the users to measure volume of a product ordered against the projected volume in the RFP or the contract and reports the level of demand of any product against a baseline or a budget. The volume compliance is especially important for the direct material categories.

### Preferred Supplier Compliance:

The system will also highlight spend from suppliers that are not contracted or preferred. The buying transactions comparing the contracts and the spend on non-preferred suppliers can be reported on a periodic basis (such as monthly basis). (FIGS. 13 and 13a)
   Buyer level Compliance:
Non-compliance by buyers using the platform (price, volume or preferred) can be reported per individual buyers. Thus management can take action for such non-compliant behavior. E.g. FIG. 19.

### Project Management Reporting

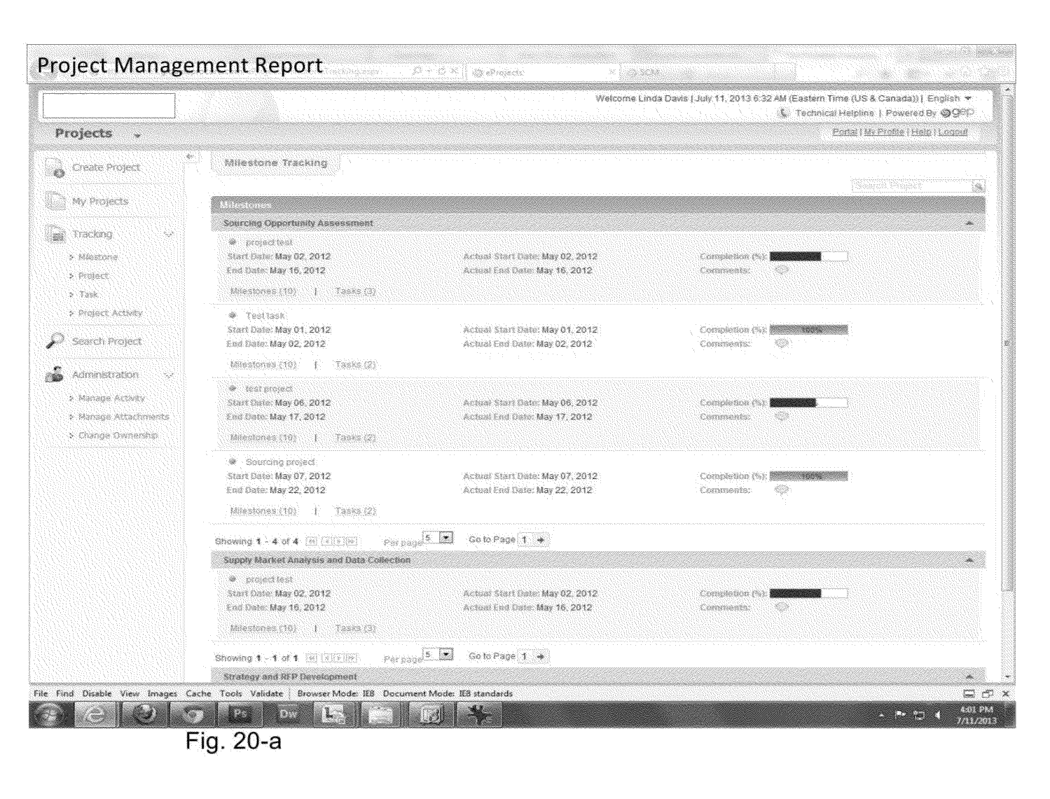

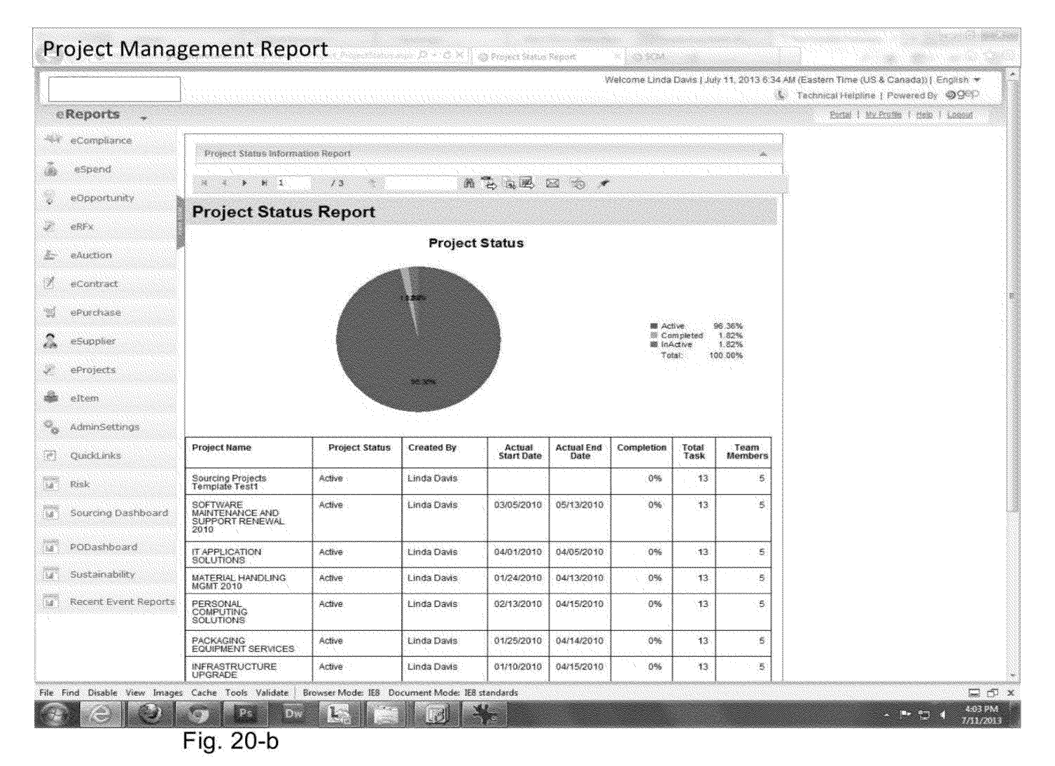

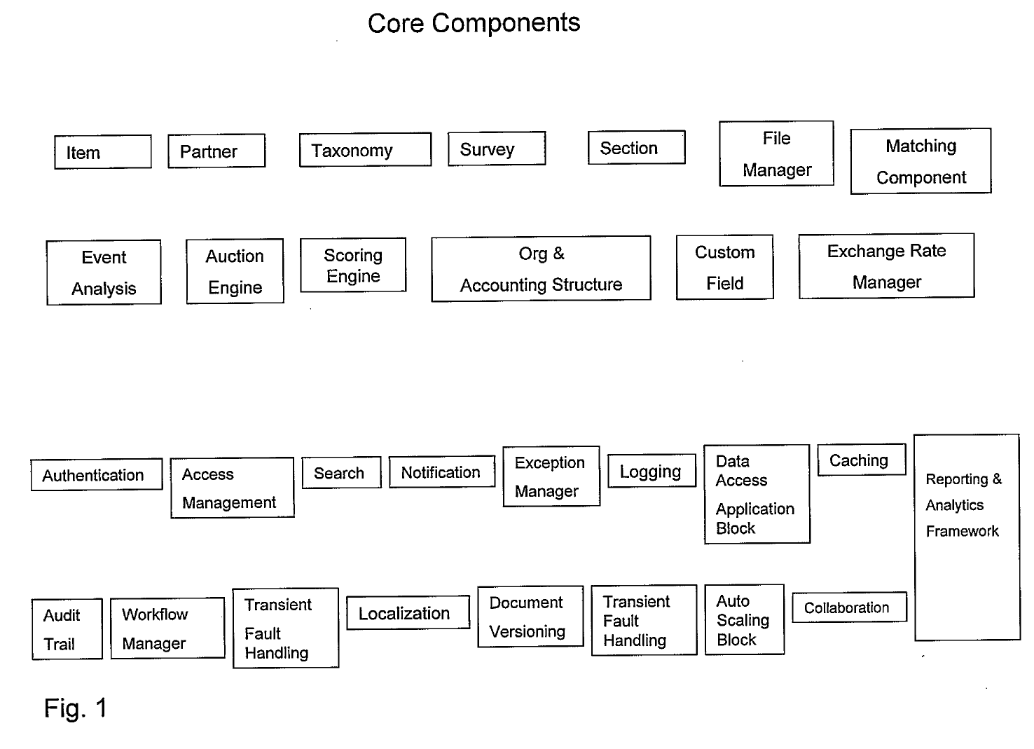

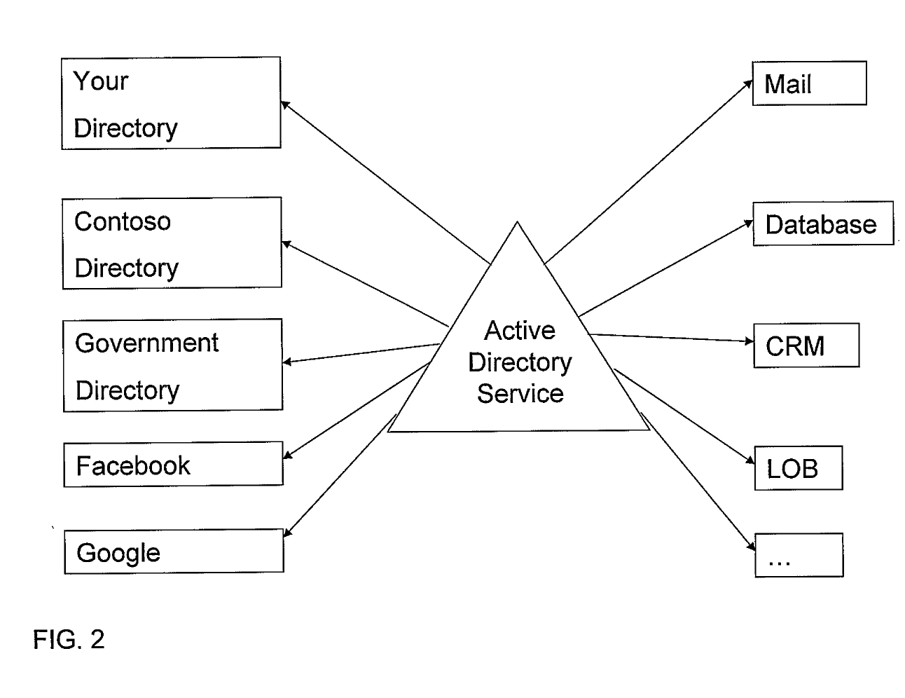

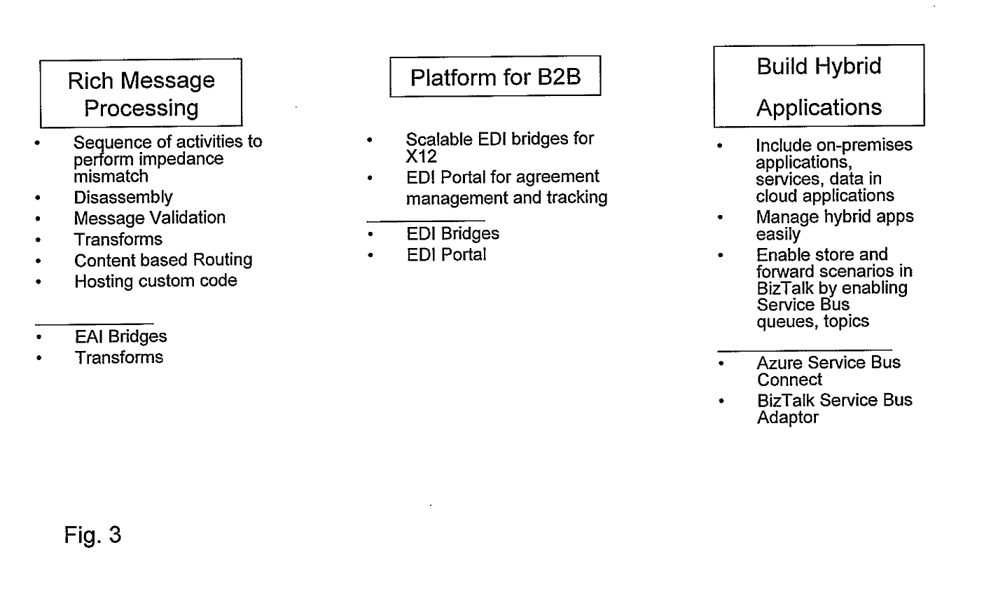

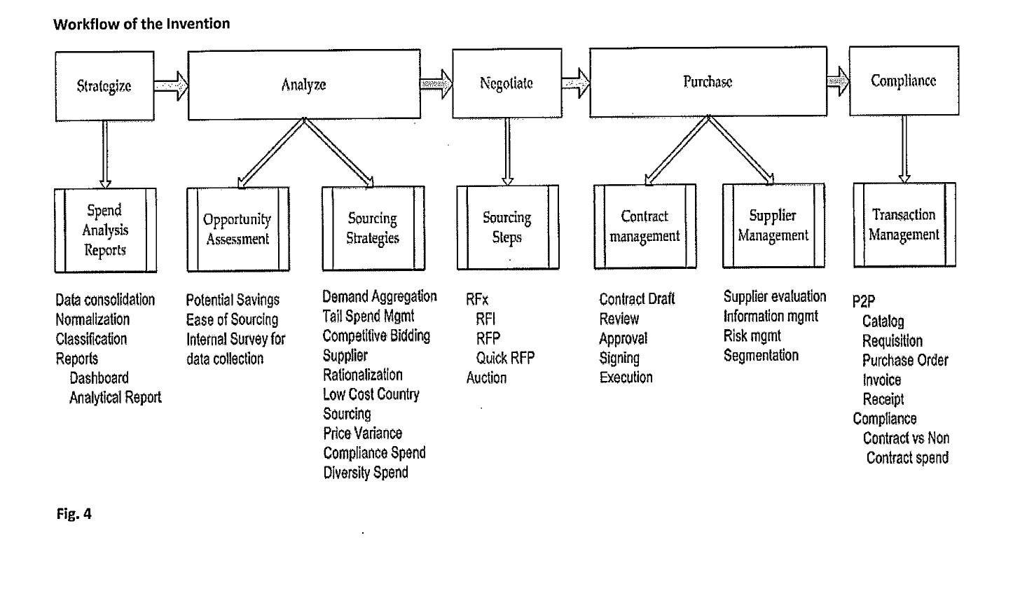

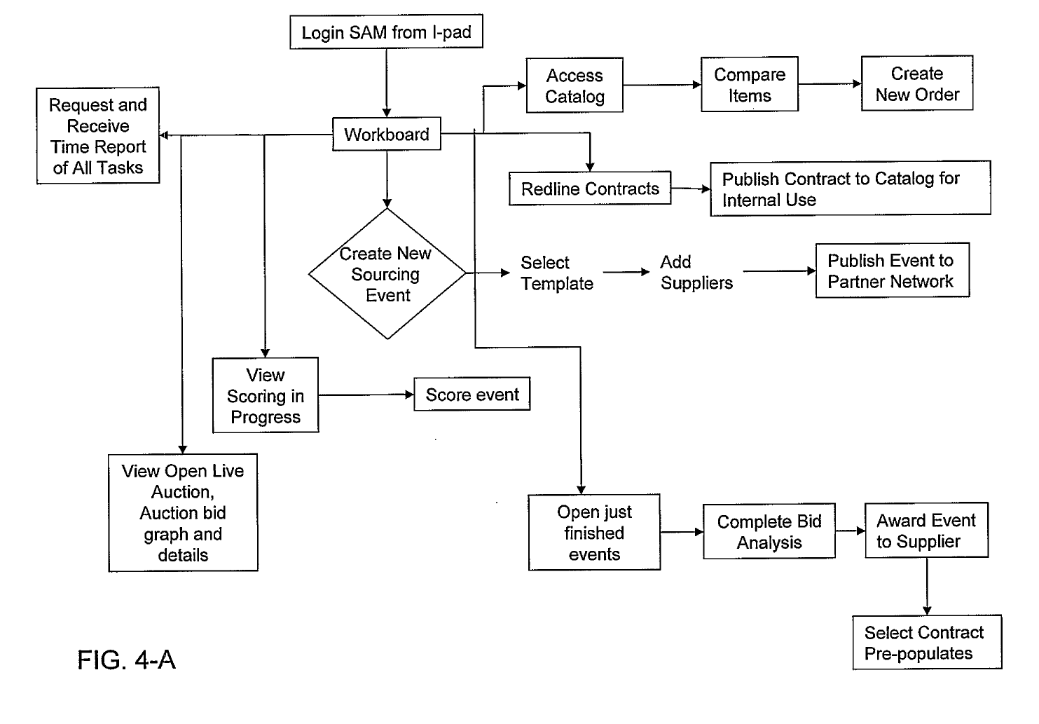

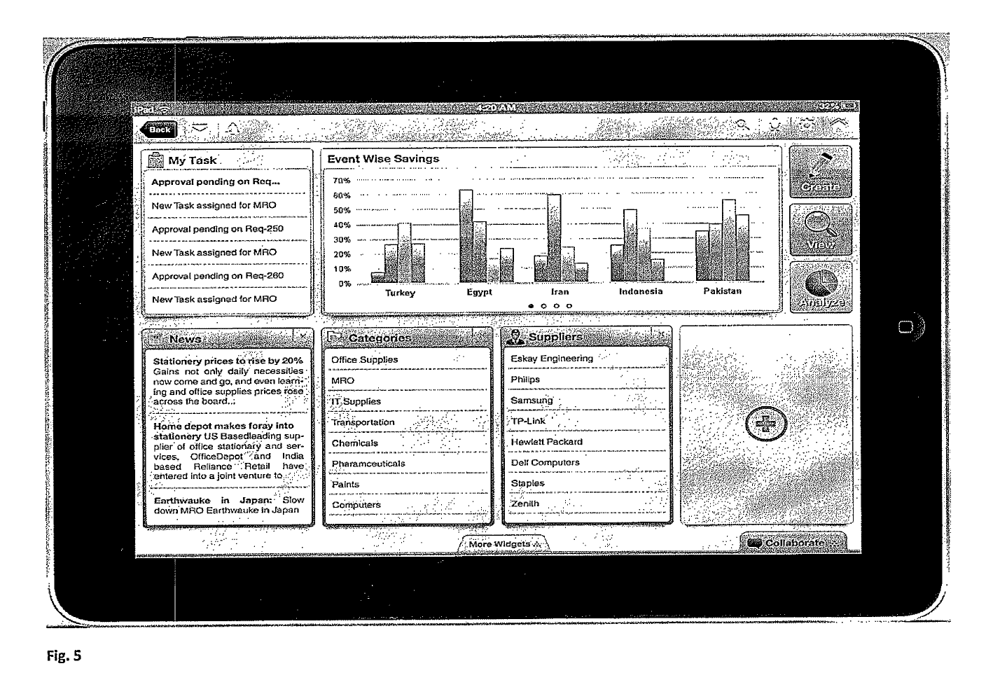

Since the user conducts all of the sourcing work in the platform, the platform can divide and track the activities in blocks of project steps. See FIGS. 4 and 20. For example,
   Spend analysis and opportunity
   Market Intelligence
   RFP Completion
   Supplier Response collection
   Negotiation
   Analysis and Supplier selection
   Contracting

Start and end time of each step is kept in the database. The user can also enter an allocated or budgeted timeline of each project step (optional) against which the system may provide a measurement or score. The platform can provide reports by each buyer for a number of open projects, works in progress, and completed projects. Currently many companies keep track of these project steps either in a separate Project Management Tool or through Excel sheets. An example of a Project Management report is shown at FIGS. 20a and 20b.

### Built in Market Intelligence Capability

Since most of the current tools used to manage spend and procurement processes and activities are not integrated or modular, it is very hard to gain intelligence from performing these tasks.

The single comprehensive platform of the present invention allows users to gain intelligence from the platform. For example, the user can obtain category specific templates, strategies, processes, pricing sheets, automated pricing index (where applicable), suppliers and even the previously ordered items for that category. This built-in market intelligence improves the productivity of the buyers and also assists in lowering the total cost of ownership for that category. The market intelligence may include: Category specific RFP templates based on sourcing expertise; a knowledge base of suppliers, items, templates and best practices; simple RFP creation, completely automated scoring; a market Intelligence workbench for category management; end to end voice based navigation for quick access; Intelligent opportunity assessment using sourcing levers like demand aggregation, supplier consolidation, etc.; a highly efficient awarding-to-contract process; single step contract-to-catalog process; OCR capability for paper based contracts and invoices; contextual and personalized search based on user's profile and activities; category specific supplier performance and risk management templates; and a unified supplier portal for sourcing and procurement tasks.

The detailed description and the accompanying drawings provide at least one example embodiment of the invention. The invention may, however, be embodied in different forms and should not be construed as limited to the example embodiments set forth herein. Rather, the example embodiments are provided so that this disclosure will be thorough and complete, and will fully convey the scope of the invention to those skilled in the art.

In this application it is understood that the terms first, second, etc. used herein to describe various elements and/or components should not limit the various elements and/or components since. The terms first, second, etc. are only used to distinguish one element and/or component from another elements and/or component. For example, a first element and/or component discussed in this application could be termed a second element and/or component without departing from the teachings associated with the example embodiments.

It is understood that various terms in the art may be used to describe a particular element and/or component. For example, it is well known that a “computer processor” is also called a “central processing unit (CPU).” As another example, it is well known that the terms “flash RAM” and “flash memory” are used interchangeably. Thus, it is understood that the terms chosen for specific elements in this application may be known by other names in the art and are therefore not intended to limit the invention.

The present invention has been described in detail with respect to several embodiments, it is not intended that the scope of the invention be limited other than as set forth in the following appended claims. For example, where specific terms are employed they are not meant to be used in any but a descriptive manner and not for purposes of limitation. Changes in the form and selection of components and/or functions, as well as in the substitution of equivalents, are contemplated as circumstances may suggest or render expedient without departing from the spirit or scope of the invention as further described in the following claims:

What we claim is:

1. A platform as a service application comprising a software framework and a hardware architecture comprising at least one computer programmed to execute a plurality of features to provide a mobile procurement platform of a component and service based design.

2. The platform of claim 1 wherein said mobile procurement platform comprises means to enable a source to settle (S2S) process workflow on a variety of mobile devices of various form factors.

3. The platform of claim 2 wherein said means include programmed functionality allowing creation, management, and analysis of events related to at least one from the group of functions consisting of: spend analysis, reverse auctions, request for proposals, requests for information, request for quote, contract management, supplier assessment, procure-to-pay, and payment settlement processes.

4. A design for a procurement-specific platform as a service application for facilitating business processes, said design comprising a software framework having a plurality of programmed re-usable core procurement functions, and a plurality of foundational components wherein said plurality of core procurement functions includes at least one of: cache manager, access control, UI generator, authentication, content delivery network, and search, said platform as a service both device and browser agnostic.

5. The design of claim 4 wherein said plurality of foundational components includes at least one of the following: item master, supplier master, procurement taxonomy, users profiles, organizational structure, survey section, file manager, event analysis, account structure, customizable fields, exchange rate monitor, authentication and access management, search function, notifications, exception manager and logging, data access application block, cashing and audit trail, workflow manager, transient fault handling block, document versioning, auto scaling, collaboration tool, and a reporting and analytical framework.

6. A platform as a service application comprising a mobile procurement platform of a component and service based design for facilitating and managing a procurement process comprising programmed means to: facilitate spend analysis, conduct reverse auctions, provide contract management, provide supplier assessment, and manage payment settlement processes.

7. The platform application of claim 6 wherein said programmed means further comprises at least one of: an item master, a supplier master, a procurement taxonomy, a file manager, a customizable field, an authentication and access management function, an exception management and logging function, a data access application block, an audit trail, a cache manager, a UI generator, an authentication function, a content delivery network, and a proposal creation and management function.

8. The design of claim 5 wherein a first selection from said plurality of core procurement functions is combined to develop at least a first business process.

9. The design of claim 5 wherein a second selection from said plurality of procurement functions is combined to develop a second business process.

10. The design of claim 5 further comprising a common set of data, said common set of data natively available for all said plurality of foundational components and all said core procurement functions without transfer of said data.

11. The design of claim 5 said design providing a plurality of benefits including identity management and single sign on through any one of several means including corporate credential, social platform authentication, and a third party authentication; integration of corporate authorization rules to govern access management of each user; support of a plurality of EAT and EDI integration standards; programming allowing use of customization tools; and scaleability.

12. The design of claim 5 said design providing: a) a consolidated view of spend across enterprise; b) a category workbench; c) a low resistance bid solicitation and negotiation system; d) a streamlined contracting process with exposure management; e) at least one supplier relationship management feature; f) access to data from at least one catalog; g) access to at least one catalog comprising pre-negotiated prices.

13. The design of claim 5 said design providing a) data incorporated from at least one catalog; b) access to at least one catalog comprising pre-negotiated prices; c) tools for creation of at least one selected from the group consisting of: invoices, requisitions, receipts, and purchase orders.

14. The design of claim 4 said design providing a) data incorporated from at least one catalog; b) access to at least one catalog comprising pre-negotiated prices; c) tools for creation of at least one selected from the group consisting of: invoices, requisitions, receipts, and purchase orders.

15. The design of claim 4 wherein said plurality of foundational components includes the following: item master, supplier master, procurement taxonomy, users profiles, organizational structure, survey section, file manager, event analysis, account structure, customizable fields, authentication and access management, search function, notifications, exception manager and logging, data access application block, workflow manager, auto scaling, collaboration tool, and a reporting and analytical framework.

16. A platform as a service application having a software framework and a hardware architecture comprising at least one computer programmed to execute a plurality of features to provide a mobile procurement platform including a sourcing market intelligence workbench.

17. The mobile procurement platform of claim 16 further comprising a plurality of programmed functions that facilitate a plurality of procurement related tasks said plurality of tasks comprising at least one from the group consisting of: spend analysis, electronic reverse auctions, contract management, supplier portal, supplier assessment, payment settlement processes, and generating electronic requests for at least one of: proposals, information, and quotes.

18. The mobile procurement platform of claim 16, said platform integrating spend, sourcing, and procurement functions.

19. The mobile procurement platform of claim 17 wherein said platform may be accessed and used from a mobile device.

20. The mobile procurement platform of claim 16 further comprising at least one tool from the following: a) at least one request-for-proposal-template; b) at least one supplier performance and risk template; c) a supplier directory.

21. The mobile procurement platform of claim 16 wherein said sourcing market intelligence workbench comprises research information, strategic plans, templates and models made accessible to all members of a specified group of users of the platform.

22. A platform as a service application comprising hardware architecture and a software framework and further comprising at least one computer programmed to execute the following functions
a) cache manage
b) access control
c) authentication
d) content delivery network,
e) search
and a plurality of foundational components.

23. The platform of claim 22 wherein said plurality of foundational components includes the following components:
a) At least one item master
b) At least one supplier master
c) A procurement taxonomy
d) At least one authentication means
e) A data access application
f) workflow manager means
g) and means for collaboration.

24. The platform of claim 23 wherein said at least one authentication means comprises a single authentication scheme selected from one or more of the following: single sign on using corporate credentials; social platform authentication.

25. The platform of claim 23 further comprising means for automating tracking and reporting savings and compliance with savings criteria.

26. The platform of claim 23 wherein said plurality of foundational components further comprises a project management tool.
